(19) United States
(12) Patent Application Publication
(10) Pub. No.: US 2021/0309943 A1
(43) Pub. Date: Oct. 7, 2021

(54) LAUNDRY DETERGENTS AND METHODS FOR MAKING AND USING SAME

(71) Applicant: Hiketron Inc., Brookshire, TX (US)

(72) Inventors: Aziz Hikem, Katy, TX (US); Tara Lee Hikem, Katy, TX (US)

(21) Appl. No.: 17/116,612

(22) Filed: Dec. 9, 2020

Related U.S. Application Data
(60) Provisional application No. 62/945,394, filed on Dec. 9, 2019.
(60) Provisional application No. 62/946,290, filed on Dec. 10, 2019.

(51) Int. Cl. C11D 11/00; C11D 1/83; C11D 3/00; C11D 3/50; C11D 3/20; C11D 3/33; C11D 3/34; C11D 3/37; C11D 3/386

(52) U.S. Cl. CPC C11D 11/0017; C11D 1/83; C11D 3/001; C11D 3/0036; C11D 3/50; C11D 1/72; C11D 3/33; C11D 3/349; C11D 3/3765; C11D 3/38618; C11D 3/2065; C11D 3/2044

(57) ABSTRACT

Ultra-concentrated (5×) laundry detergent compositions including one or more surfactant materials, one or more processing aid materials, one or more softener materials, one or more preservative materials, one or more chelating agent materials, and one or more anti-deposition agent materials. In certain embodiments, the ultra-concentrated (5×) laundry detergents include one or more stain remover materials. In other embodiments, the ultra-concentrated (5×) laundry detergents are scented with one or more fragrance materials, wherein the base composition are capable of accommodating up to 30 wt. % of one or more fragrance materials without adversely affecting detergent properties, wherein the laundry detergent compositions including the one or more fragrance materials are in the form of an emulsion or more likely a micro-emulsion of the one or more fragrance materials in the base detergent compositions.

### RELATED APPLICATIONS

This application claims the benefit of and priority to U.S. Provisional Patent Application Serial Nos. 62/945,394 filed Dec. 9, 2019 (9 Dec. 2019) and 62/946,290 filed Dec. 10, 2019 (10 Dec. 2019), incorporated by reference by action of the closing paragraph.

### BACKGROUND OF THE DISCLOSURE

### 1. Field of the Disclosure

Embodiments of the present disclosure relate to scented and unscented ultra concentrated laundry detergent compositions. The unscented ultra concentrated laundry detergent base compositions may include one or more surfactant materials, one or more processing aid materials, one or more softener materials, one or more preservative materials, one or more chelating agent materials, one or more anti-deposition agent materials, or any combination of the one or more surfactant materials and other materials. In certain embodiments, the ultra concentrated laundry detergents may also include one or more stain removing materials such as stain removing enzyme materials. In other embodiments, the ultra concentrated laundry detergent compositions may also include one or more fragrance materials.

In particular, embodiments of the present disclosure relate to scented and unscented ultra concentrated laundry detergent compositions may include one or more surfactant materials, one or more processing aid materials, one or more softener materials, one or more preservative materials, one or more chelating agent materials, one or more anti-deposition agent materials, or any combination of the one or more surfactant materials and other materials. In certain embodiments, the ultra concentrated laundry detergent compositions may also include one or more stain removing materials such as stain removing enzyme materials. In other embodiments, the ultra concentrated laundry detergent compositions may also include one or more fragrance materials. In other embodiments, the scented ultra concentrated laundry detergent compositions may include between about 95 wt. % and about 70 wt. % of one or more unscented ultra concentrated laundry detergent base compositions and between about 5 wt. % and about 30 wt. % of one or more fragrance materials, where the fragrance materials are distributed in the unscented laundry detergent compositions as emulsions or micro-emulsions and are efficiently released when the scented ultra concentrated laundry detergent compositions are dispersed in water during cloth washing.

### 2. Description of the Related Art

While there are many laundry detergents, there is still a need in the art for improved laundry detergent systems and methods that have bases that are capable of accommodating large amount of fragrances.

### SUMMARY OF THE DISCLOSURE

Embodiments of the present disclosure provide unscented ultra concentrated laundry detergent compositions including one or more laundry detergent base compositions. The one or more laundry detergent base compositions may include one or more surfactant materials, one or more processing aid materials, one or more softener materials, one or more preservative materials, one or more chelating agent materials, one or more anti-deposition agent materials, or any combination of the one or more surfactant materials and other materials. In certain embodiments, the unscented ultra concentrated laundry detergent compositions may also include one or more stain removing materials such as stain removing enzyme materials.

Embodiments of the present disclosure provide scented ultra concentrated laundry detergent compositions including one or more laundry detergent base compositions and one or more fragrance materials. In other embodiments, the scented ultra concentrated laundry detergent compositions include between about 95 wt. % and about 70 wt. % of one or more ultra concentrated laundry detergent base compositions and between about 5 wt. % and about 30 wt. % of one or more fragrance materials.

Embodiments of the present disclosure methods for making scented ultra concentrated laundry detergent compositions mixing appropriate amounts of one or more surfactant materials, one or more processing aid materials, one or more softener materials, one or more preservative materials, one or more chelating agent materials, one or more anti-deposition agent materials, or any combination of the one or more surfactant materials and other materials for a time, at a temperature, and at a pressure to form the scented ultra concentrated laundry detergent compositions, wherein the time is between 10 minutes and 4 hours, the pressure is between about 0.5 atmospheres and 1.5 atmospheres, and the temperature is between 15° C. and 40° C. In certain embodiments, the time is between 10 minutes and 2 hours, the pressure is between about 0.9 atmospheres and 1.1 atmospheres, and the temperature is between 20° C. and 40° C. In certain embodiments, the time is between 20 minutes and 1 hours, the pressure is between about 1.0 atmosphere, and the temperature is between 20° C. and 30° C. In other embodiments, the unscented ultra concentrated laundry detergent compositions may also include one or more stain removing materials such as stain removing enzyme materials.

### Definitions Used in the Disclosure

The term “at least one”, “one or more”, and “one or a plurality” means one item or more than one item. For example, at least one, one or more, one or a plurality of devices means one device or more than one devices.

The term “about” means that a value of a given quantity is within +20% of the stated value. In other embodiments, the value is within +15% of the stated value. In other embodiments, the value is within +10% of the stated value. In other embodiments, the value is within +5% of the stated value. In other embodiments, the value is within +2.5% of the stated value. In other embodiments, the value is within +1% of the stated value.

The term “substantially” or “essentially” means that a value of a given quantity is within+5% of the stated value. In other embodiments, the value is within +2.5% of the stated value. In other embodiments, the value is within +2% of the stated value. In other embodiments, the value is within +1% of the stated value. In other embodiments, the value is within +0.1% of the stated value.

The term “essentially free” or “substantially free” means that the composition includes less than about 1 wt. % of a particular ingredient. In other embodiments, the composition includes less than about 0.5 wt. % of the particular ingredient. In other embodiments, the composition includes less than about 0.25 wt. % of the particular ingredient. In other embodiments, the composition includes less than about 0.1 wt. % of the particular ingredient. In other embodiments, the composition includes less than about 0.05 wt. % of the particular ingredient.

The terms “wt. %”, “% by weight”, or “w/w” all mean percent by weight based on a specific weight of a composition.

The terms “vol. %”, “% by volume”, or “v/v” all mean percent by volume based on a specific volumetric composition.

The term “w/v” means a percentage by weight based on a given volume of a specific volumetric composition.

The term “v/w” means a percentage by volume based on a given weight of a specific composition.

All ranges, whether integer or real, include all subranges with include of the endpoints unless otherwise stated. For example, a range between about 1 and about 50 includes 1 and 50 and all subranges of real value end point from 1 to 49 or between 50 and 2 in any increments.

### DETAILED DESCRIPTION OF THE DISCLOSURE

The inventor has found that new scented and unscented ultra concentrated laundry detergent compositions may be prepared using biodegradable and hypoallergenic laundry detergent base compositions and fragrance compositions to reduce allergy reactions. The ultra concentrated laundry detergent base compositions include one or more surfactant systems, one or more processing aids, one or more softeners, one or more preservatives, one or more chelating agents, and one or more anti-deposition agents. In certain embodiments, the ultra concentrated laundry detergent compositions include one or more enzymes. In other embodiments, the ultra concentrated laundry detergent compositions are scented further including fragrance compositions. The inventors have found the 5× concentrated laundry detergent compositions are based on the use of naturally derived, sugar-based surfactants prepared by combining glucose with natural fatty alcohol and processing then further to create a mild, sulfate-free cleansing agent. Thus, the present laundry compositions are essentially free of sulfate surfactants including anionic sulfate surfactants and cationic sulfate surfactants and essentially free of sulfonate surfactants.

Embodiments of the present disclosure relate broadly to laundry detergent base compositions including: one or more surfactant materials, one or more processing aid materials, one or more softener materials, one or more preservative materials, one or more chelating agent materials, and one or more anti-deposition agent materials. In certain embodiments, the compositions further include between about 70 wt. % and about 95 wt. % of the one or more surfactant materials, and between about 30 wt. % and about 5 wt. % of a mixture of the one or more processing aid materials, the one or more softener materials, the one or more preservative materials, the one or more chelating agent materials, the one or more anti-deposition agent materials. In other embodiments, the mixture includes between about 3.0 wt. % and about 16.0 wt. % of the one or more processing aid materials, between about 0.1 wt. % and about 0.5 wt. % of the one or more chelating agents, between about 0.1 wt. % and about 6.0 wt. % of the one or more preservatives, between about 0.1 wt. % and about 0.5 wt. % of the one or more anti-deposition agent materials, between about 1.0 wt. % and about 5.0 wt. % of one or more softener materials, and between about 1.0 wt. % and about 3.0 wt. % of one or more enzyme stain remover materials. In other embodiments, the composition further include between about 90 wt. % and about 95 wt. % of the one or more surfactant materials, and between about 10 wt. % and about 5 wt. % of a mixture of the one or more processing aid materials, the one or more softener materials, the one or more preservative materials, the one or more chelating agent materials, the one or more anti-deposition agent materials. In other embodiments, the mixture includes between about 2.0 wt. % and about 4.0 wt. % of the one or more processing aid materials, between about 0.1 wt. % and about 0.5 wt. % of the one or more chelating agents, between about 0.1 wt. % and about 1.0 wt. % of the one or more preservatives, between about 0.1 wt. % and about 0.5 wt. % of the one or more anti-deposition agent materials, between about 1.0 wt. % and about 3.0 wt. % of one or more softener materials, and between about 1.0 wt. % and about 3.0 wt. % of one or more enzyme stain remover materials. The above compositions are essentially free of anionic surfactants.

Embodiments of the present disclosure relate broadly to laundry detergent composition including between about 95 wt. % and about 70 wt. % of a laundry detergent base composition, and between about 5 wt. % and about 30 wt. % of one or more fragrance materials. In certain embodiments, the laundry detergent base composition includes between about 70 wt. % and about 95 wt. % of the one or more surfactant materials, and between about 30 wt. % and about 5 wt. % of a mixture of the one or more processing aid materials, the one or more softener materials, the one or more preservative materials, the one or more chelating agent materials, the one or more anti-deposition agent materials. In other embodiments, the mixture includes between about 3.0 wt. % and about 16.0 wt. % of the one or more processing aid materials, between about 0.1 wt. % and about 0.5 wt. % of the one or more chelating agents, between about 0.1 wt. % and about 6.0 wt. % of the one or more preservatives, between about 0.1 wt. % and about 0.5 wt. % of the one or more anti-deposition agent materials, between about 1.0 wt. % and about 5.0 wt. % of one or more softener materials, and between about 1.0 wt. % and about 3.0 wt. % of one or more enzyme stain remover materials. In other embodiments, the compositions further include between about 90 wt. % and about 70 wt. % of the laundry detergent base, and between about 10 wt. % and about 30 wt. % of the one or more fragrance materials. In other embodiments, the compositions further include between about 85 wt. % and about 70 wt. % of the laundry detergent base, and between about 15 wt. % and about 30 wt. % of the one or more fragrance materials. In other embodiments, the compositions further include between about 80 wt. % and about 70 wt. % of the laundry detergent base, and between about 20 wt. % and about 30 wt. % of the one or more fragrance materials. In other embodiments, the compositions further include between about 95 wt. % and about 75 wt. % of the laundry detergent base, and between about 5 wt. % and about 25 wt. % of the one or more fragrance materials. In other embodiments, the compositions further include between about 95 wt. % and about 80 wt. % of the laundry detergent base, and between about 5 wt. % and about 20 wt. % of the one or more fragrance materials. In other embodiments, the compositions further include between about 95 wt. % and about 85 wt. % of the laundry detergent base, and between about 5 wt. % and about 15 wt. % of the one or more fragrance materials. In other embodiments, the compositions further include between about 95 wt. % and about 90 wt. % of the laundry detergent base, and between about 5 wt. % and about 10 wt. % of the one or more fragrance materials.

The inventor believes that the scented laundry detergents form a clear emulsion or micro-emulsion allowing the fragrance materials to be released efficiently when the scented ultra concentrated laundry detergent compositions contact water in the washing machine. The laundry detergents of this disclosure are designed to be efficient and effective 5X ultra concentrated products shipped in 40 fluid ozone containers to minimized environment impact. The detergents are designed to reduce the need for other laundry products such as separate stain removers, fabric softeners, pre-spotters, or drier sheets. The design of detergent chemistry to help clean the washing machine during use to reduce the need for separate cleaning The detergents require no thickeners reducing build up of polymer materials that tend to clog washing machine. The detergents are biodegradable using sugar-based surfactants, are safe on all fabrics, colors and whites, free of dyes, optical brighteners, phosphates, sulfate, and dioxane. The detergents deliver a long-lasting scent and eliminates body odors to achieve a long-lasting scent without the need scent boosters. The 40 fl oz bottles provide easy storage and handling requiring less displace room and storage volumes. The laundry detergents are designed for hand washing, standard washing machines, and high efficiency machines. The laundry detergents provide enhanced energy and water efficiency with cold water washing, helps in softening fabrics and reduce wrinkles, and are safe to use with chlorine bleach or oxygen bleaches. The fragrances are generally hypo-allergenic essential oils or hypoallergenic synthetic fragrances generally making up less than 5% of the total fragrance material. In certain embodiments, the synthetic fragrances make up less than 2.5% of the fragrance material. In certain embodiments, the synthetic fragrances make up less than 1% of the fragrance material. In certain embodiments, the synthetic fragrances are present in an amount between about 0.1% and 5% of the fragrance material. In certain embodiments, the synthetic fragrances are present in an amount between about 0.1% and 4% of the fragrance material. In certain embodiments, the synthetic fragrances are present in an amount between about 0.1% and 3% of the fragrance material. In certain embodiments, the synthetic fragrances are present in an amount between about 0.1% and 2% of the fragrance material. In certain embodiments, the synthetic fragrances are present in an amount between about 0.1% and 1% of the fragrance material.

### Suitable Components for Use in the Disclosure

suitable emulsifiers for use in the compositions of this disclosure include, without limitation, fatty acid amine oxides such as lauramine oxide, such as Cola®Lux LO, CAS Number:1643-20-5, available from Colonial Chemical, Inc., trialkanolamines such as triethanolamine,

suitable concentrate surfactant materials for use in the compositions of this disclosure include, without limitation, one or more naturally derived, sugar-based surfactants prepared by combining glucose with one or mor natural fatty alcohols such as fatty alcohols derived from coconut oil, from capric acid, from lauric acid, and/or myristic acids as well as other fatty acids and processing it further to create a mild, sulfate-free cleansing composition. Exemplary examples of such sugar-based surfactants include, without limitation, alkali alkyl polyglucoside, alkali fatty acid glucosides such as sodium laurylglucosides such as Suga®Nate 160NC, CAS Number:742087-49-6, available from Colonial Chemical, Inc. Other exemplary examples include, without limitation, coco glucosides non-ionic surfactant that is obtained from coconut oil and fruit sugars, decyl glucoside is very similar to coco glucoside (non-ionic and ECOCERT compatible), but it has a shorter chain length, lauryl glucosides, capryl glucosides, myristryl glucosides, alkyl polypentosides, or mixtures and combinations thereof.

suitable stain remover materials for use in the compositions of this disclosure include, without limitation, stabilized enzyme composition include a mixture of enzymes. Exemplary examples of enzymes include, without limitation, mannanase (mannan endo-1,4-beta-mannosidase), lipase, cellulase, alpha-amylase, pectate lyase, protease (subtilisin), and mixtures or combinations thereof and such as a Novozymes' enzyme preparations, called Medley Brilliant 100 L, available from Novozymes North America, Inc.

Suitable processing aid materials for use in the compositions of this disclosure include, without limitation, glycols, oligoglycols, polyglycols, and mixtures or combinations thereof

Suitable chelating agent materials for use in the compositions of this disclosure include, without limitation, tetrasodium glutamate diacetate, alkali salts of ethylenediamine tetraacetic acid, other chelating agents, ethylene diamine tetraacetic acid (EDTA), nitrilotriacetic acid (NTA), and tripolyphosphate (TPP) sodium salts, and mixtures of combinations thereof.

Suitable preservative materials for use in the compositions of this disclosure include, without limitation, diazolidinyl urea, propylene glycol, imidazolidinyl urea, 1,2-benzisothiazolin-3-(2H)-one 5-chloro-2-methyl-4-isothiaz olin-3-one; 2-methyl-4-isothiaz olin-3-one, gluteraldehyde (glutaral), hexahydro-1,3,5-tris(hydroxyethyp-s-triazine (triazine), phenoxyethanol, methylparaben, ethylparaben, propylparaben, butylparaben, isobutylparaben, methylchloroisothiazolinone, methylisothiazolinone, hydantoin, chloroxylenol, and mixtures or combinations thereof.

Suitable anti-deposition agent materials for use in the compositions of this disclosure include, without limitation, liquid acrylate homopolymers, liquid methacrylate homopolymers, liquid acylate coplymers, liquid methacrylate copolymers, liquid acylate and methacrylate coplymers, sodium carboxymethylcellulose, carboxymethylcellulose, polyethylene glycol, methylcellulose, polyvinylpyrrolidone (PVP), polyvinyl alcohol, polyethylene glycol (PEG), and mixtures or combinations thereof.

Suitable softener materials for use in the compositions of this disclosure include, without limitation, glycerine, mono-glycerides, di-glycerides, triglycerides, pine oil, tallows, fatty acid alcohols, fatty acids, animal and vegetable oils and fats, hydrolyzed proteins and polymers compositions such as Coltide Radiance available from Croda Home Care and those set forth in United States Published ApplicationNo. 20190106625 and 20160075944, any other component used as softeners for laundry detergent or to reduce microfiber production during washing, and mixtures or combinations thereof.

Suitable fragrance materials for use in the compositions of this disclosure include, without limitation, essential oils and hypoallergenic synthetic fragrances, and mixtures thereof. Exemplary examples of some specific fragrance embodiments include, without limitation, Royal Linen fragrance, Cotton Fresh fragrance, lavender & chamomile fragrance, Bold Man fragrance, Mambo Man fragrance, suit up fragrance, essential oils, and mixtures or combinations thereof.

Suitable other or additional fragrance materials for use in this disclosure include, without limitation, acai berry, absinthe, agave lime, aldehydic, allspice, almond, almond biscotti, almond & honey, almond macaroon, aloe, amaretto, amber, amber musk, ambergris, ambrosia, amish friendship bread, amish harvest, angel food cake, anise, apple, apple berry, apple blossom, apple butter pie, apple cider, apple cinnamon, apple cinnamon streusel, apple crisp, apple crumb cake, apple dumpling, applejack, apple spice, apple orchard, apple pear, apple pie, apple pie, homemade, apples & berries, apples and oak, appletini, apricot, apricot & cream, apricot freesia, apricot mango, asian pear and lily, asian plum, autumn splendor, autumn time leaf, autumn time wreath, avocado, azalea, baby powder, bacon, baked bread, balsam fir, balsam pine, balsamic greens & grapefruit, bamboo, banana, banana cream pie, banana kiwi, banana nut bread, banana taffy, basil, basil sage mint, bay, bayberry, bay rum, beragamot, berries & cream, berry blossom, birds of paradise, birthday cake, biscotti, biscotti:chocolate, black currant, black fig and honey, black licorice, black raspberry, blackberry cream vanilla, blackberry jam, blackberry pie, blackberry sage, blueberry, blueberry cheesecake, blueberry cobbler, blueberry flapjacks, blueberry muffin, blueberry patch, blueberry pie, blue raspberry, bouquet, boston cream pie, boysenberry, bright blossoms, brown sugar, brown sugar dates and fig, brownie, bubble gum, butt naked, butter cookie, butter pecan pie, butter rum, buttercream, buttercream crunch, buttered popcorn, buttermint candy, butterscotch, butterscotch & vanilla, cabernet, cactus flower, cafe mocha, cake bake, calla lily, campfire marshmallow, campfire smoke, camphor, candied chestnuts, candy apple, candy cane, candy corn, cannabis flower, cantaloupe, cantaloupe melon, cappuccino, capri seaside citrus, caramel, caramel apple, caramel popcorn, cardamon cedar blossom, carnation, carribbean coconut, carrot cake, casablanca lily, cashmere bouquet, cassia, cassis, cedar, chai tea, chamomile, champagne, champagne pear, champagne & roses, chardonnay, cheesecake, cherry, cherry blossom, cherry cheesecake, cherry chocolate, cherry cobbler, cherry crumb pie, cherry pie, cherry tobacco, cherry, black, cherry, red, cherry vanilla, chestnuts & brown sugar, china rain, chocolate, chocolate chip cookies, chocolate covered strawberries, chocolate fudge, chocolate mint, chocolate mousse, chocolate raspberry, chocolate sugar cookies, chocolate syrup, christmas cheer, christmas cookie, christmas memories, christmas splendor, christmas tree, chrysanthemum, chypre, churo, cilantro, cinnamon, cinnamon buns, cinnamon cookie dough, cinnamon donut, cinnamon orange, cinnamon raisin bread, cinnamon red hot, cinnamon sugar, cinnamon stick, cinnamon toast, cinnamon toffee, citronella, citronella, citrus, citrus blast, citrus blossom, citrus cilantro, citrus lotus, citrus sage, citrus splash, clean & fresh, clean linen, clementine, clove, clover, coco mango, cocoa butter, cocoa mango, coconut, coconut almond, coconut beach, coconut cream pie, coconut lemongrass, coconut lime vervain, coconut macaron, coconut, creamy, coffee, coffee cake spice, coffee w/creme, cognac, cola, cola rose, cola, cherry, cola, chocolate, cookie dough, cookies for santa, cookies n cream, cool citrus basil, corn, cornucopia, cotton candy, countryberryhotcakes, country christmas, country clothesline, country meadow, country spice, crab apple, cran-apple, cran-orange, cranberry, cranberry cobbler, cranberry currant, cranberry orange, cranberry relish, cranberry spice, creamsicle, cream sorbet, creme brulee, crisp morning air, cucumber, cucumber mint, cucumbers & melons, cupcake, cyclamen, cyprus & citron, daffodil, dahlia, daisy, dandelion, delicious apple, delphinium, desert flowers, dewberry, dirt, dogwood, douglas fir, dragon's blood, dream-sickle, driftwood, earth, egg nog, elderberry wine, english ivy, english lavender, eucalyptus, eucalyptus spearmint, evergreen, expresso, everglades, evergreen forest, fern, fireplace, fig, floral bouquet, floral potpourri, flower shop, flowering dogwood, forest pine, forsythia, frangipan, frankincense, frankincense & myrrh, freesia, french market, fresh cut grass, fresh & clean, fresh linen, fresh outdoors, fresh squeezed orange, frozen margarita, fruit bouquet, fruit cocktail, fruity floral, fuzzy navel, garden mint, gardenia, gardenia lily, bay rum, georgia peach, geranium, german chocolate cake, ginger, ginger blossom, gingerbread, gingerbread cookie, ginger fig, ginger hawaiian, ginger kiwi, ginger lime, ginger orange, ginger peach, ginger pumpkin, ginger snap, ginger spice, gladiola, goat milk & honey, gooseberry, gourmet dark chocolate, graham cracker, grandma's kitchen, grape, grape concord, grape soda, grapefruit, grapefruit pink, grapefruit ruby red, grapefruit rhubarb, green clover and aloe, green floral, green mint, green tea, green tea & cucumber, guarana, guava, guess for men, harvest, hawaiian flower, hawaiian ginger, hawaiian punch, hayride, hazelnut, hazelnut coffee, heartfelt floral, heather, heliotrope, hemlock, herbal, herbal mint, herbal mist, hibiscus, hollyberry, home sweet home, honey, honey almond, honeydew melon, honeysuckle, hot backed apple pie, hot buttered rum, hot chocolate, hot cocoa, hot fudge brownie, hot orange danish, hot toddy, huckleberry, hyacinth, hydrangea, iced cinnamon rolls, iced pineapple, iced tea twist, impatients, indian sandalwood, indian summer, iris, irish cream, island breeze, italian biscotti, jack's frosty nose, jamaica me crazy, jasmine, jasmine gardenia, jelly beans, jelly doughnut, juniper, juniper breeze, just peachy, kailua, kettle corn, key lime pie, kiwi, kiwi strawberry, kiwi watermelon, kudzu, kumquat, lavanda, lavender, lavender apple, lavender & basil, lavender fields, lavender flowers, lavender, french, lavender sage, lavender & lemongrass, lavender martini, lavender vanilla, leather, lemon, lemon cheesecake, lemon chiffon, lemon drops, lemon ice, lemon meringue pie, lemon peel, lemon poppyseed, lemon pound cake, lemon pucker, lemon squares, lemon sugar, lemon tea cake, lemon verbena mint, lemonade, lemongrass, lemongrass sage, lemon lime, lemon verbena, lick me all over, licorice, lilac, lily, lily of the valley, lime, lime cilantro, linen breeze, log cabin, loganberry, lotus blossom, lotus, macadamia nut, madagascar spice, magnolia & orange blossom, magnolia, mandarin, mandarin lime, mango, mango coconut, mango mandarin, mango & melon, mango peach, mango sorbet, mango tango twist, maple, maple fudge, maple pecan, maple sugar, maple syrup, mangosteen, maple walnut fudge, marichino cherry, margarita, maricopa, marigold, marmalade, marshmallow, mask odor, mayan gold, medicinal, melon, menthol, merlot wine, midsummer, mimosa, mint, mint chocolate chip, mint julep, mistletoe, mixed berries, mocha java, modern, mojito, money, monkey farts, morning glory, mountain air, moss, mulberry, mulberry spice, mulled cider, muscadine, musk, myrrh, nag champp, narcissus, new mown hay, neroli, neutroleum alpha, new car scent, nutmeg, nutty taffy apples, o'christmas tree, oak & apples, oakmoss, oatmeal cookies, oatmeal,milk & honey, oatmeal raisin cookie, ocean breeze, ocean mist, odor mask, odor neutralizers, olive blossom, orange, orangesicle, orange blossom, orange burst, orange & cinnamon, orange clove, orange cranberry, orange fresh, orange fruit, orange juice, orange peel, orange sherbet, orange spice, orchid, orchid blossom, orchid rain, oriental, orris root, oud, pansy, papaya, papaya mango, papaya tangerine, paper whites, paradise punch, passion flower, passion fruit, passionate smooch, passionflower & acai berry, patchouli, peach, peach blossom, peach, fresh, peaches n'cream, peach brandy, peach cobbler, peach nectar, peach preserves, peanut butter cookie, peanut butter cup, pear, pear, spiced, pearberry, pears n'berries, pecan, pecan pie, pecan & pralines, peony, peppercorn, peppermint, peppermint stick, persimmon spice, periwinkle, pie crust, pikake flowers, pina colada, pine, pine forest, pine, pinion, pineapple, pineapple cilantro, pineapple upside down cake, pink bubblegum, pink salt & water lily, pink grapefruit, pink lemonade, pistachio, pizza, plum, plum pudding, plumeria, poinsettia, pomegranate, pomegranate, midnight, pomegranate martini, pomegranate quince, popcorn, poppy, potpourri, potpourri spice, powder, primrose, pumpkin, pumpkin apple butter, pumpkin cheesecake, pumpkin crunch cake, pumpkin eggnog, pumpkin patch, pumpkin pie, pumpkin pie spice, pumpkin spice, rain, rainforest, raspberry, raspberry cream, raspberry guava, raspberry sorbets, raspberry truffle, red currant, red currant & thyme, red hot cinnamon, red raspberry, red velvet cake, redwood embers, rhubarb, rice flower & shea, ripened raspberry, roasted chestnut, root beer, root beer float, rose, rose geranium, rose jasmine, rosemary, rosemary mint, rosewood, rum ripened raisin, s'mores, sage, sage leaf, sage & citron, sage, sweetgrass & cedar, sandalwood, sandalwood vanilla, sassafras, satin sheets, satsuma, sea breeze, seasons greetings, sex on the beach, shiraz, shortbread, sinus relief, sleigh bells, sleigh ride, smoke out, snapdragon, snicker doodle, spearmint, spice, spice cake, spiced apple pecan, spiced chestnut, spiced coffee cake, spiced cranberry, spiced gum drops, spiced sugar plum, spiced tea, spring air, spring bloom, spring rain, spring shower, spruce, strawberries-n-cream, strawberry, strawberry cheesecake, strawberry daiquiri, strawberry jam, strawberry-kiwi, strawberry patch, strawberry preserves, strawberry rhubarb pie, strawberry shortcake, strawberry wine, sugar champagne, sugar cookie, sugar plum, summer blossoms, sun dried cotton, sun dried linen, suntan oil, sweetgrass, sweet orange chili pepper, sweet pea, sweet potatoe pie, syringa, taffy, tamarind nectarine, tangerine, teaberry, tea rose, teakwood, three wise men, thyme, tibetan black tea, tiger lily, toasted marshmallow, tobacco, toffee maple crunch, tomato basil, tomato leaf, tonka bean, tropical delight, tropical mango, tropical paradise, truffles, tuberose, tulip, tuscan wine, tutti fruitti, twigs & berries, vanilla almond, vanilla, vanilla bean, vanilla bean xmas, vanilla berry, vanilla blossom, vanilla,bourbon, vanilla caramel, vanilla, cherry, vanilla, cinnamon, vanilla, coconut, vanilla cream, vanilla extract, vanilla fantasy, vanilla, french, vanilla grapefruit, vanilla hazelnut, vanilla musk, vanilla, nutty, vanilla, orange, vanilla spice, vanilla sugar, vanilla velvet, vanilla wafer, verbena, verbena & lemon, vetiver, victorian christmas, vineyard grape, vintage gardenia, violet, vitiver wood, waffle cone, walnut, warm rustic woods, warm vanilla & sugar, wassail, water-blown cotton, water lily, watermelon, wedding cake, wedding day, white chocolate, white chocolate truffle, white christmas, white citrus, white gardenia, white linen, white nectarine, white tea & ginger, white tea, white truffle raspberry, wildberry, wild flower, wild honeysuckle, wild grass fields, wild mountain berry, wine cellar, wine & roses, winter garden, wintermint, wintergreen, wisteria, witches magical brew, woodberry, woodland, xmas wreath, ylang ylang, yuzu, zinfindel, zinnia, zucchini bread, or mixtures thereof. While the fragrances may be synthetic, most of the detergents of this disclosure use fragrance having less than 5 wt. % synthetic fragrances based on the amount of fragrance added.

### Experiments of the Disclosure

The illustrative examples set forth below relate to ultra concentrated laundry detergents, wherein the detergents are 3 times to 6 times ultra concentrated liquid laundry detergents.

The laundry detergent compositions of this disclosure include, without limitation, (a) unscented formulations such as general unscented formulations, unscented baby formulation, and unscented pet formulation and (b) scented formulations such as scented formulations for men, scented formulations for women, scented baby formulations, and unscented pet formulations.

The Examples set forth below used the following ingredients: A laundry detergent base comprising a sodium laurylglucosides hydroxypropylsulfonate composition (CAS #742087-49-6). A processing aid comprising a 1,2-propanediol composition (CAS #57-55-6). A chelating agent comprising a tetrasodium N,N-bis(carboxymethyl)-L-glutamate composition (CAS #51981-21-6). A preservative comprising a 1,2-benzisothiazol-3(2H)-one composition (CAS #2634-33-5), an ethoxylated C12-16 alcohol composition, wherein the ethoxylation is between 1 and 6 (CAS #68551-12-2), or mixtures thereof. An anti-deposition agent comprising a poly(acrylic acid sodium salt) composition (CAS #9003-04-7). An enzyme stain remover comprising a blend of proteinases from bacillus licheniformis, Subtilisin A (CAS #9014-01-1). The softener is a 1,2,3-propanetriol, glycerol composition (CAS #56-81-5). While specific materials have been used to illustrate specific embodiments of the laundry detergents of this disclosure, the specific embodiments are only for illustration and other specific materials of like kind may be separately or mixed with these specific components.

### EXAMPLE 1

This examples illustrates the formulation of an unscented 5× ultra concentrated liquid laundry detergent.

The unscented 5× ultra concentrated liquid laundry detergent includes the following ingredients in the designated amounts.

| Component | CAS # | Physical State | SG | lbs/gal | wt. % | lbs | gals |
|---|---|---|---|---|---|---|---|
| Laundry Detergent Base | 742087-49-6 | Liquid | 1.190 | 9.93 | 90.9 | 281.8 | 28.38 |
| Processing Aid | 57-55-6 | Liquid | 1.040 | 8.68 | 3.0 | 9.3 | 1.07 |
| Chelating Agent | 51981-21-6 | Liquid | 1.300 | 10.85 | 2.0 | 6.2 | 0.57 |
| Preservative | 2634-33-5 | Liquid | 1.140 | 9.51 | 0.1 | 0.3 | 0.03 |
| Anti-deposition Agent | 9003-04-7 | Liquid | 1.400 | 11.68 | 1.0 | 3.1 | 0.27 |
| Enzyme Stain Remover | 9014-01-1 | Liquid | 1.000 | 8.35 | 3.0 | 9.3 | 1.11 |
| | | | | Totals | 100.00 | 310.00 | 31.43 |

The laundry detergent base is available from Colonial Chemicals, the processing aid is available from Harcros Chemicals Inc., the chelating agent is available from Harcros Chemicals Inc., the preservative is available from Harcros Chemicals Inc., the anti-deposition agent is available from Harcros Chemicals Inc., and enzyme blend is available from Jtech Sales. The laundry detergent base is a sodium laurylglucosides hydroxypropylsulfonate composition. The processing aid is a 1,2-propanediol composition. The chelating agent is a tetrasodium N,N-bis(carboxymethyl)-L-glutamate composition. The preservative is a 1,2-benzisothiazol-3(2H)-one composition. The anti-deposition agent is a poly(acrylic acid sodium salt) composition. The enzyme stain remover is a blend of proteases from bacillus licheniformis.

The unscented 5× ultra concentrated liquid laundry detergent had the following physical properties.

PHYSICAL PROPERTIES

| | | Range | |
|---|---|---|---|
| Property | Batch Value | Minimum value | Maximum Value |
| Appearance | Clear liquid | Clear Liquid | Slightly Hazy |
| Color | Pale yellow | Pale Yellow | Dark yellow |
| pH Neat @20° C. | 9.5 | 9.3 | 9.7 |
| Specific Gravity | 1.12 | 0.92 | 1.32 |
| Bulk Density (lb/gal) | 9.01 | 7.38 | 10.68 |
| Viscosity (CP) @300 | 263.5 | 253.5 | 273.5 |
| rpm @20° C. | | | |

### EXAMPLE 2

This examples illustrates the formulation of a scented 5× ultra concentrated liquid laundry detergent.

The scented 5× ultra concentrated liquid laundry detergent includes the following ingredients in the designated amounts.

| Component | CAS # | Physical State | SG | lbs/gal | wt. % | lbs | gal |
|---|---|---|---|---|---|---|---|
| Laundry Detergent Base | 742087-49-6 | Liquid | 1.190 | 9.93 | 61.49 | 190.6 | 19.20 |
| Processing Aid | 57-55-6 | Liquid | 1.040 | 8.68 | 15.37 | 47.6 | 5.49 |
| Chelating Agent | 51981-21-6 | Liquid | 1.300 | 10.85 | 0.20 | 0.6 | 0.06 |
| Preservative | 68551-12-2 | Liquid | 1.140 | 9.51 | 4.61 | 14.3 | 1.50 |
| Preservative | 2634-33-5 | Liquid | 1.140 | 9.51 | 0.10 | 0.3 | 0.03 |
| Anti-deposition Agent | 9003-04-7 | Liquid | 1.400 | 11.68 | 0.21 | 0.7 | 0.06 |
| Softener | 56-81-5 | Liquid | 1.300 | 10.85 | 5.12 | 15.9 | 1.46 |
| Fragrance | Mixture | Liquid | 0.950 | 7.93 | 12.90 | 40.0 | 5.04 |
| | | | | Totals | 100.00 | 310.00 | 34.10 |

The laundry detergent base is available from Colonial Chemicals, the processing aid is available from Harcros, the softener is available from Harcros, the preservative is available from Harcros, the chelating agent is available from Harcros, the preservative is available from Harcros, the anti-deposition agent is available from Harcros, and the fragrance is available from D&D Fragrance.

The scented 5× ultra concentrated liquid laundry detergent had the following physical properties.

PHYSICAL PROPERTIES

| | Batch | Range | |
|---|---|---|---|
| Property | Value | Minimum value | Maximum Value |
| Appearance | Clear liquid | Clear Liquid | Slightly Hazy |
| Color | Pale yellow | Pale Yellow | Dark yellow |
| pH Neat @20° C. | 8.4 | 8.2 | 8.6 |
| Specific Gravity | 1.09 | 0.89 | 1.29 |
| Bulk Density (lb/gal) | 9.09 | 7.42 | 10.76 |
| Viscosity (CP) @ 300 | 74.8 | 64.8 | 84.8 |
| rpm @20° C. | | | |

The scented 5× ultra concentrated liquid laundry detergent is prepared by adding the other ingredients to the base with mixing.

MIXING FORMULA

| Volume To make | wt. % | lbs |
|---|---|---|
| Base-101 | 87.10 | 270.0 |
| Royal Linen Fragrance | 12.90 | 40.0 |
| Total | 100 | 310.00 |

### EXAMPLE 3

This examples illustrates the formulation of a scented 5× ultra concentrated liquid laundry detergent.

The scented 5× ultra concentrated liquid laundry detergent includes the following ingredients in the designated amounts.

| Component | CAS # | Physical State | SG | lbs/gal | wt. % | lbs | gal |
|---|---|---|---|---|---|---|---|
| Laundry Detergent Base | 742087-49-6 | Liquid | 1.190 | 9.93 | 61.49 | 190.62 | 19.20 |
| Processing Aid | 57-55-6 | Liquid | 1.040 | 8.68 | 15.37 | 47.65 | 5.49 |
| Chelating Agent | 51981-21-6 | Liquid | 1.300 | 10.85 | 0.20 | 0.62 | 0.06 |
| Preservative | 68551-12-2 | Liquid | 1.140 | 9.51 | 4.61 | 14.29 | 1.50 |
| Preservative | 2634-33-5 | Liquid | 1.140 | 9.51 | 0.10 | 0.31 | 0.03 |
| Anti-deposition Agent | 9003-04-7 | Liquid | 1.400 | 11.68 | 0.21 | 0.65 | 0.06 |
| Softener | 56-81-5 | Liquid | 1.300 | 10.85 | 5.12 | 15.87 | 1.46 |
| Fragrance | N/A | Liquid | 0.975 | 8.14 | 12.90 | 39.99 | 4.91 |
| | | | | Totals | 100.00 | 310.00 | 34.41 |

The laundry detergent base is available from Colonial Chemicals, the process aid is available from Harcros, the softener is available from Harcros, the preservative is available from Harcros, the chelating agent is available from Harcros, the preservative is available from Harcros, the anti-deposition agent is available from Harcros, and the fragrance is available from D&D Fragrance.

The scented 5× ultra concentrated liquid laundry detergent had the following physical properties.

PHYSICAL PROPERTIES

| | Batch | Range | Maximum |
|---|---|---|---|
| Property | Value | Minimum value | Value |
| Appearance | Clear liquid | Clear Liquid | Slightly Hazy |
| Color | Pale yellow | Pale Yellow | Slightly Hazy |
| pH Neat @20° C. | 8.6 | 8.4 | Dark yellow |
| Specific Gravity | 1.08 | 0.88 | 8.8 |
| Bulk Density (lb/gal) | 9.01 | 7.38 | 10.68 |
| Viscosity (CP) @300 | 65 | 55 | 10.68 |
| rpm @20° C. | | | |

The scented 5× ultra concentrated liquid laundry detergent is prepared by adding the other ingredients to the base with mixing.

MIXING FORMULA

| Volume To make | wt. % | lbs |
|---|---|---|
| Base-101 | 87.10 | 270.0 |
| Cotton Fresh Fragrance | 12.90 | 40.0 |
| Totals | 100 | 310.00 |

### EXAMPLE 4

This examples illustrates the formulation of a scented 5× ultra concentrated liquid laundry detergent for babies.

The scented 5× ultra concentrated liquid laundry detergent includes the following ingredients in the designated amounts.

| Component | CAS # | Physical State | SG | lbs/gal | wt. % | lbs | gal |
|---|---|---|---|---|---|---|---|
| Laundry Detergent Base | 742087-49-6 | Liquid | 1.190 | 9.93 | 88.2 | 273.42 | 27.53 |
| Processing Aid | 57-55-6 | Liquid | 1.040 | 8.68 | 5.0 | 15.50 | 1.79 |
| Chelating Agent | 51981-21-6 | Liquid | 1.300 | 10.85 | 2.0 | 6.20 | 0.57 |
| Preservative | 2634-33-5 | Liquid | 1.140 | 9.51 | 0.1 | 0.31 | 0.03 |
| Anti-redeposition Agent | 9003-04-7 | Liquid | 1.400 | 11.68 | 1.0 | 3.10 | 0.27 |
| Enzyme Stain Remover | 9014-01-1 | Liquid | 1.000 | 8.35 | 3.0 | 9.30 | 1.11 |
| Fragrance | N/A | Liquid | 0.940 | 7.84 | 0.7 | 2.17 | 0.28 |
| | | | | Totals | 100.00 | 310.00 | 34.41 |

The cleaner is available from Colonial Chemicals, the enzyme stabilizer is available from Harcros, the chelating agent is available from Harcros, the preservative is available from Harcros, the anti-redeposition agent is available from Harcros, the enzyme stain remover is available from Jtech Sales, and the fragrance is available from D & D Fragrance.

The scented 5× ultra concentrated liquid laundry detergent had the following physical properties.

PHYSICAL PROPERTIES

| | Batch | Range | |
|---|---|---|---|
| Property | Value | Minimum value | Maximum Value |
| Appearance | Clear liquid | Clear Liquid | Slightly Hazy |
| Color | Pale yellow | Pale Yellow | Dark yellow |
| pH Neat @20° C. | 9.5 | 9.3 | 9.7 |
| Specific Gravity | 1.12 | 0.92 | 1.32 |
| Bulk Density (lb/gal) | 9.01 | 7.38 | 10.68 |
| Viscosity (CP) @300 | 263.5 | 253.5 | 273.5 |
| rpm @20° C. | | | |

The scented 5× ultra concentrated liquid laundry detergent is prepared by adding the other ingredients to the base with mixing.

MIXING FORMULA

| Volume To make | wt. % | lbs |
|---|---|---|
| Base-101 | 95 | 294.50 |
| Medley Brilliant 100 L | 3 | 9.30 |
| Lavender & Chamomile Fragrance | 2 | 6.20 |
| Totals | 100% | 310.00 |

### EXAMPLE 5

This examples illustrates the formulation of a scented 5× ultra concentrated liquid laundry detergent for pets.

The scented 5× ultra concentrated liquid laundry detergent includes the following ingredients in the designated amounts.

| Component | CAS # | Physical State | SG | lbs/gal | wt. % | lbs | gal |
|---|---|---|---|---|---|---|---|
| Cleaner | 742087-49-6 | Liquid | 1.190 | 9.93 | 88.2 | 273.42 | 27.53 |
| Processing Aid | 57-55-6 | Liquid | 1.040 | 8.68 | 5.0 | 15.50 | 1.79 |
| Chelating Agent | 51981-21-6 | Liquid | 1.300 | 10.85 | 2.0 | 6.20 | 0.57 |
| Preservative | 2634-33-5 | Liquid | 1.140 | 9.51 | 0.1 | 0.31 | 0.03 |
| Anti-deposition Agent | 9003-04-7 | Liquid | 1.400 | 11.68 | 1.0 | 3.10 | 0.27 |
| Enzyme Stain Remover | 9014-01-1 | Liquid | 1.000 | 8.35 | 3.0 | 9.30 | 1.11 |
| Fragrance | N/A | Liquid | 0.940 | 7.84 | 0.7 | 2.17 | 0.28 |
| | | | | Totals | 100.00 | 310.00 | 34.41 |

The cleaner is available from Colonial Chemicals, the enzyme is available from Harcros chelaing agent is available from Harcros, the preservative is available from Harcros, the anti-deposition agent is available from Harcros, and the enzyme stain remover is available from Jtech Sales fragrance is available from D&D Fragrance.

The scented 5× ultra concentrated liquid laundry detergent had the following physical properties.

PHYSICAL PROPERTIES

| | Batch | Range | |
|---|---|---|---|
| Property | Value | Minimum value | Maximum Value |
| Appearance | Clear liquid | Clear Liquid | Slightly Hazy |
| Color | Pale yellow | Pale Yellow | Dark yellow |
| pH Neat @20° C. | 9.5 | 9.3 | 9.7 |
| Specific Gravity | 1.12 | 0.92 | 1.32 |
| Bulk Density (lb./gal) | 9.01 | 7.38 | 10.68 |
| Viscosity (CP) @300 | 263.5 | 253.5 | 273.5 |
| rpm @20° C. | | | |

The scented 5× ultra concentrated liquid laundry detergent is prepared by adding the other ingredients to the base with mixing.

MIXING FORMULA

| Volume To make | wt. % | lbs |
|---|---|---|
| Base-101 | 95 | 294.50 |
| Medley Brilliant 100 L | 3 | 9.30 |
| Lavender & Chamomile Fragrance | 2 | 6.20 |
| Total | 100 | 310.00 |

### EXAMPLE 6

This examples illustrates the formulation of a scented 5× ultra concentrated liquid laundry detergent.

The scented 5× ultra concentrated liquid laundry detergent includes the following ingredients in the designated amounts.

| Component | CAS # | Physical State | SG | lbs/gal | wt. % | lbs | gal |
|---|---|---|---|---|---|---|---|
| Laundry Detergent Base | 742087-49-6 | Liquid | 1.190 | 9.93 | 61.49 | 190.6 | 19.20 |
| Processing Aid | 57-55-6 | Liquid | 1.040 | 8.68 | 15.37 | 47.6 | 5.49 |
| Chelating Agent | 51981-21-6 | Liquid | 1.300 | 10.85 | 0.20 | 0.6 | 0.06 |
| Preservative | 68551-12-2 | Liquid | 1.140 | 9.51 | 4.61 | 14.3 | 1.50 |
| Preservative | 2634-33-5 | Liquid | 1.140 | 9.51 | 0.10 | 0.3 | 0.03 |
| Anti Deposition Agent | 9003-04-7 | Liquid | 1.400 | 11.68 | 0.21 | 0.7 | 0.06 |
| Softener | 56-81-5 | Liquid | 1.300 | 10.85 | 5.12 | 15.9 | 1.46 |
| Fragrance | N/A | Liquid | 0.944 | 7.88 | 12.90 | 40.0 | 5.08 |
| | | | | Totals | 100.00 | 310.00 | 34.41 |

The laundry detergent base is available from Colonial Chemicals, the processing aid is available from Harcros, the softener is available from Harcros, the preservative is available from Harcros, the chelating agent is available from Harcros, the preservative is available from Harcros, the anti-deposition agent is available from Harcros, and the fragrance is available from D&D Fragrance.

The scented 5× ultra concentrated liquid laundry detergent had the following physical properties.

PHYSICAL PROPERTIES

| | | Range | |
|---|---|---|---|
| Property | Batch Value | Minimum value | Maximum Value |
| Appearance | Clear liquid | Clear Liquid | Slightly Hazy |
| Color | Light Amber | Light Amber | Dark Amber |
| pH Neat @20° C. | 8.12 | 7.92 | 8.32 |
| Specific Gravity | 1.08 | 0.88 | 1.28 |
| Bulk Density (lb/gal) | 9.01 | 7.34 | 10.68 |
| Viscosity (CP) @300 | 59.3 | 49.3 | 69.3 |
| Rpm @20° C. | | | |

The scented 5× ultra concentrated liquid laundry detergent is prepared by adding the other ingredients to the base with mixing.

MIXING FORMULA

| Volume To make | wt. % | lbs |
|---|---|---|
| Base-101 | 87.10 | 270.0 |
| Bold Man Fragrance | 12.90 | 40.0 |
| Totals | 100 | 310.00 |

EXAMPLE 7

This examples illustrates the formulation of a scented 5× ultra concentrated liquid laundry detergent.

The scented 5× ultra concentrated liquid laundry detergent includes the following ingredients in the designated amounts.

| Component | CAS # | Physical State | SG | lbs/gal | wt. % | lbs | gal |
|---|---|---|---|---|---|---|---|
| Laundry Detergent Base | 742087-49-6 | Liquid | 1.190 | 9.93 | 61.49 | 190.6 | 19.20 |
| Processing Aid | 57-55-6 | Liquid | 1.040 | 8.68 | 15.37 | 47.6 | 5.49 |
| Chelating Agent | 51981-21-6 | Liquid | 1.300 | 10.85 | 0.20 | 0.6 | 0.06 |
| Preservative | 68551-12-2 | Liquid | 1.140 | 9.51 | 4.61 | 14.3 | 1.50 |
| Preservative | 2634-33-5 | Liquid | 1.140 | 9.51 | 0.10 | 0.3 | 0.03 |
| Anti Deposition Agent | 9003-04-7 | Liquid | 1.400 | 11.68 | 0.21 | 0.7 | 0.06 |
| Softener | 56-81-5 | Liquid | 1.300 | 10.85 | 5.12 | 15.9 | 1.46 |
| Fragrance | | Liquid | 0.950 | 7.93 | 12.90 | 40.0 | 5.04 |
| | | | | Totals | 100.00 | 310.00 | 33.81 |

The laundry detergent base is available from Colonial Chemicals, the processing aid is available from Harcros, the softener is available from Harcros, the preservative is available from Harcros, the chelating agent is available from Harcros, the preservative is available from Harcros, the anti-deposition agent is available from Harcros, and the fragrance is available from D&D Fragrance.

The scented 5× ultra concentrated liquid laundry detergent had the following physical properties.

PHYSICAL PROPERTIES

| | Batch | Range | |
|---|---|---|---|
| Property | Value | Minimum value | Maximum Value |
| Appearance | Clear liquid | Clear Liquid | Slightly Hazy |
| Color | Pale yellow | Pale Yellow | Dark yellow |
| pH Neat @20° C. | 8.16 | 7.96 | 8.36 |
| Specific Gravity | 1.1 | 0.89 | 1.3 |
| Bulk Density (lb/gal) | 9.17 | 8.97 | 9.37 |
| Viscosity (CP) @300 | 81.3 | 71.3 | 91.3 |
| Rpm @20° C. | | | |

The scented 5× ultra concentrated liquid laundry detergent is prepared by adding the other ingredients to the base with mixing.

MIXING FORMULA

| Volume To make | wt. % | lbs |
|---|---|---|
| Base-101 | 87.10 | 270.0 |
| Mambo Man Fragrance | 12.90 | 40.0 |
| Total | 100 | 310.00 |

### EXAMPLE 8

This examples illustrates the formulation of a scented 5× ultra concentrated liquid laundry detergent.

The scented 5× ultra concentrated liquid laundry detergent includes the following ingredients in the designated amounts.

| Component | CAS # | Physical State | SG | lbs/gal | wt. % | lbs | gal |
|---|---|---|---|---|---|---|---|
| Laundry Detergent Base | 742087-49-6 | Liquid | 1.190 | 9.93 | 61.49 | 190.6 | 19.20 |
| Processing Aid | 57-55-6 | Liquid | 1.040 | 8.68 | 15.37 | 47.6 | 5.49 |
| Chelating Agent | 51981-21-6 | Liquid | 1.300 | 10.85 | 0.20 | 0.6 | 0.06 |
| Preservative | 68551-12-2 | Liquid | 1.140 | 9.51 | 4.61 | 14.3 | 1.50 |
| Preservative | 2634-33-5 | Liquid | 1.140 | 9.51 | 0.10 | 0.3 | 0.03 |
| Anti-deposition Agent | 9003-04-7 | Liquid | 1.400 | 11.68 | 0.21 | 0.7 | 0.06 |
| Softener | 56-81-5 | Liquid | 1.300 | 10.85 | 5.12 | 15.9 | 1.46 |
| Fragrance | | Liquid | 0.950 | 7.93 | 12.90 | 40.0 | 5.04 |
| | | | | Totals | 100.00 | 310.00 | 34.41 |

The laundry detergent base is available from Colonial Chemicals, the processing aid is available from Harcros, the softener is available from Harcros, the preservative is available from Harcros, the chelating agent is available from Harcros, the preservative is available from Harcros, the anti-deposition agent is available from Harcros, and the fragrance is available from D&D Fragrance.

The scented 5× ultra concentrated liquid laundry detergent had the following physical properties.

PHYSICAL PROPERTIES

| | Batch | Range | |
|---|---|---|---|
| Property | Value | Minimum value | Maximum Value |
| Appearance | Clear liquid | Clear Liquid | Slightly Hazy |
| Color | Pale yellow | Pale Yellow | Dark yellow |
| pH Neat @20° C. | 8.32 | 8.18 | 8.52 |
| Specific Gravity | 1.08 | 0.88 | 1.28 |
| Bulk Density (lb/gal) | 9.01 | 7.34 | 10.68 |
| Viscosity (CP) @300 | 73.1 | 63.1 | 83.1 |
| Rpm @20° C. | | | |

The scented 5× ultra concentrated liquid laundry detergent is prepared by adding the other ingredients to the base with mixing.

MIXING FORMULA

| Volume To make | wt. % | lbs |
|---|---|---|
| Base-101 | 87.10 | 270.0 |
| Suit Up Fragrance | 12.90 | 0.0 |
| Total | 100 | 310.00 |

### EXAMPLE 9

This examples illustrates the formulation of a 5× ultra concentrated liquid laundry detergent base.

The 5× ultra concentrated liquid laundry detergent base includes the following ingredients in the designated amounts.

| Component | Cas # | Physical State | SG | lbs/gal | Wt. % | Lbs | Gal |
|---|---|---|---|---|---|---|---|
| Laundry Detergent Base | 742087-49-6 | Liquid | 1.190 | 9.93 | 70.59 | 974.1 | 98.09 |
| Processing Aid | 57-55-6 | Liquid | 1.040 | 8.68 | 17.65 | 243.5 | 28.06 |
| Chelating Agent | 51981-21-6 | Liquid | 1.300 | 10.85 | 0.24 | 3.2 | 0.30 |
| Preservative | 68551-12-2 | Liquid | 1.140 | 9.51 | 5.29 | 73.0 | 7.67 |
| Preservative | 2634-33-5 | Liquid | 1.140 | 9.51 | 0.12 | 1.6 | 0.17 |
| Anti-deposition Agent | 9003-04-7 | Liquid | 1.400 | 11.68 | 0.24 | 3.3 | 0.28 |
| Softener | 56-81-5 | Liquid | 1.300 | 10.85 | 5.88 | 81.2 | 7.48 |
| | | | | Totals | 100.00 | 1,380.00 | 150.00 |

The laundry detergent base is available from Colonial Chemicals, the processing aid is available from Harcros, the softener is available from Harcros, the preservative is available from Harcros, the chelating agent is available from Harcros, the preservative is available from Harcros, and the anti-deposition agent is available from Harcros.

The 5× ultra concentrated liquid laundry detergent base had the following physical properties.

PHYSICAL PROPERTIES

| | Batch | Range | |
|---|---|---|---|
| Property | Value | Minimum value | Maximum Value |
| Appearance | Clear liquid | Clear Liquid | Slightly Hazy |
| Color | Pale yellow | Pale Yellow | Dark yellow |
| pH Neat @20° C. | 8.6 | 7.4 | 8.8 |
| Specific Gravity | 1.1 | 0.9 | 1.3 |
| Bulk Density (lb/gal) | 9.2 | 7.51 | 10.84 |
| Viscosity (CP) @300 | 41 | 31 | 51 |
| Rpm @20° C. | | | |

### Closing Paragraph of the Disclosure

All references cited herein are incorporated by reference. Although the disclosure has been disclosed with reference to its preferred embodiments, from reading this description those of skill in the art may appreciate changes and modification that may be made which do not depart from the scope and spirit of the disclosure as described above and claimed hereafter.

We claim:

1. A laundry detergent base composition comprising:
one or more surfactant materials,
one or more processing aid materials,
one or more softener materials,
one or more preservative materials,
one or more chelating agent materials, and
one or more anti-deposition agent materials.

2. The composition of claim 1, further comprising:
between about 70 wt. % and about 95 wt. % of the one or more surfactant materials, and between about 30 wt. % and about 5 wt. % of a mixture of the one or more processing aid materials, the one or more softener materials, the one or more preservative materials, the one or more chelating agent materials, and the one or more anti-deposition agent materials.

3. The composition of claim 2, further comprising:
one or more stain removing materials.

4. The composition of claim 3, wherein:
the mixture comprises:
between about 3.0 wt. % and about 16.0 wt. % of the one or more processing aid materials,
between about 0.1 wt. % and about 0.5 wt. % of the one or more chelating agents,
between about 0.1 wt. % and about 6.0 wt. % of the one or more preservatives,
between about 0.1 wt. % and about 0.5 wt. % of the one or more anti-deposition agent materials,
between about 1.0 wt. % and about 5.0 wt. % of one or more softener materials, and
between about 1.0 wt. % and about 3.0 wt. % of one or more stain remover materials.

5. The composition of claim 3, further comprising:
between about 90 wt. % and about 95 wt. % of the one or more surfactant materials, and
between about 10 wt. % and about 5 wt. % of a mixture of the one or more processing aid materials, the one or more softener materials, the one or more preservative materials, the one or more chelating agent materials, the one or more anti-deposition agent materials.

6. The composition of claim 5, wherein:
the mixture comprises:
between about 2.0 wt. % and about 4.0 wt. % of the one or more processing aid materials,
between about 0.1 wt. % and about 0.5 wt. % of the one or more chelating agents,
between about 0.1 wt. % and about 1.0 wt. % of the one or more preservatives,
between about 0.1 wt. % and about 0.5 wt. % of the one or more anti-deposition agent materials,
between about 1.0 wt. % and about 3.0 wt. % of one or more softener materials, and
between about 1.0 wt. % and about 3.0 wt. % of one or more stain remover materials.

7. The composition of claim 1, further comprising:
between about 95 wt. % and about 70 wt. % of a laundry detergent base composition, and
between about 5 wt. % and about 30 wt. % of one or more fragrance materials

8. The composition of claim 7, further comprising:
between about 90 wt. % and about 70 wt. % of the laundry detergent base, and between about 10 wt. % and about 30 wt. % of the one or more fragrance materials,
between about 85 wt. % and about 70 wt. % of the laundry detergent base and between about 15 wt. % and about 30 wt. % of the one or more fragrance materials, or
between about 80 wt. % and about 70 wt. % of the laundry detergent base and between about 20 wt. % and about 30 wt. % of the one or more fragrance materials.

9. The composition of claim 7, wherein the composition comprising:
between about 95 wt. % and about 75 wt. % of the laundry detergent base, and between about 5 wt. % and about 25 wt. % of the one or more fragrance materials,
between about 95 wt. % and about 80 wt. % of the laundry detergent base, and between about 5 wt. % and about 20 wt. % of the one or more fragrance materials, or
between about 95 wt. % and about 85 wt. % of the laundry detergent base, and between about 5 wt. % and about 15 wt. % of the one or more fragrance materials, or
between about 95 wt. % and about 90 wt. % of the laundry detergent base, and between about 5 wt. % and about 10 wt. % of the one or more fragrance materials.

10. A laundry detergent composition comprising:
between about 95 wt. % and about 70 wt. % of a laundry detergent base composition, and between about 5 wt. % and about 30 wt. % of one or more fragrance materials.

11. The composition of claim 10, wherein:
the laundry detergent base composition includes:
between about 70 wt. % and about 95 wt. % of the one or more surfactant materials, and
between about 30 wt. % and about 5 wt. % of a mixture of the one or more processing aid materials, the one or more softener materials, the one or more preservative materials, the one or more chelating agent materials, the one or more anti-deposition agent materials, and one or more stain remover materials.

12. The composition of claim 11, wherein:
the mixture comprises:
between about 3.0 wt. % and about 16.0 wt. % of the one or more processing aid materials,
between about 0.1 wt. % and about 0.5 wt. % of the one or more chelating agents,
between about 0.1 wt. % and about 6.0 wt. % of the one or more preservatives,
between about 0.1 wt. % and about 0.5 wt. % of the one or more anti-deposition agent materials,
between about 1.0 wt. % and about 5.0 wt. % of one or more softener materials, and
between about 1.0 wt. % and about 3.0 wt. % of one or more stain remover materials.

13. The composition of claim 10, further comprising:
between about 90 wt. % and about 70 wt. % of the laundry detergent base, and between about 10 wt. % and about 30 wt. % of the one or more fragrance materials,
between about 85 wt. % and about 70 wt. % of the laundry detergent base and between about 15 wt. % and about 30 wt. % of the one or more fragrance materials, or
between about 80 wt. % and about 70 wt. % of the laundry detergent base and between about 20 wt. % and about 30 wt. % of the one or more fragrance materials.

14. The composition of claim 10, wherein the composition comprising:
between about 95 wt. % and about 75 wt. % of the laundry detergent base, and between about 5 wt. % and about 25 wt. % of the one or more fragrance materials, or
between about 95 wt. % and about 80 wt. % of the laundry detergent base, and between about 5 wt. % and about 20 wt. % of the one or more fragrance materials, or
between about 95 wt. % and about 85 wt. % of the laundry detergent base, and between about 5 wt. % and about 15 wt. % of the one or more fragrance materials, or
between about 95 wt. % and about 90 wt. % of the laundry detergent base, and between about 5 wt. % and about 10 wt. % of the one or more fragrance materials.

15. A method comprising:
mixing between about 70 wt. % and about 95 wt. % of the one or more surfactant materials, and between about 30 wt. % and about 5 wt. % of a mixture of the one or more processing aid materials, the one or more softener materials, the one or more preservative materials, the one or more chelating agent materials, the one or more anti-deposition agent materials for a time between 10 minutes and 4 hours, a pressure between about 0.5 atmospheres and 1.5 atmospheres, and a temperature between 15° C. and 40° C.

16. The method of claim 15, wherein, in the mixing step:
the time is between 10 minutes and 2 hours, the pressure is between about 0.9 atmospheres and 1.1 atmospheres, and the temperature is between 20° C. and 40 ° C. or the time is between 20 minutes and 1 hour, the pressure is between about 1.0 atmospheres, and the temperature is between 20° C. and 30° C.

17. The method of claim 15, wherein, in the mixing step:
the mixture comprises:
between about 3.0 wt. % and about 16.0 wt. % of the one or more processing aid materials,
between about 0.1 wt. % and about 0.5 wt. % of the one or more chelating agents,
between about 0.1 wt. % and about 6.0 wt. % of the one or more preservatives,
between about 0.1 wt. % and about 0.5 wt. % of the one or more anti-deposition agent materials,
between about 1.0 wt. % and about 5.0 wt. % of one or more softener materials, and
between about 1.0 wt. % and about 3.0 wt. % of one or more enzyme stain remover materials.

18. The method of claim 15, wherein, in the mixing step:
the composition further comprises:
between about 95 wt. % and about 70 wt. % of a laundry detergent base composition, and
between about 5 wt. % and about 30 wt. % of one or more fragrance materials.

19. The method of claim 18, wherein, in the mixing step:
the composition further comprises:
between about 90 wt. % and about 70 wt. % of the laundry detergent base, and
between about 10 wt. % and about 30 wt. % of the one or more fragrance materials, or
between about 85 wt. % and about 70 wt. % of the laundry detergent base, and
between about 15 wt. % and about 30 wt. % of the one or more fragrance materials, or
between about 80 wt. % and about 70 wt. % of the laundry detergent base, and
between about 20 wt. % and about 30 wt. % of the one or more fragrance materials.

20. The method of claim 15, wherein the composition comprising:
the composition further comprises:
between about 95 wt. % and about 75 wt. % of the laundry detergent base, and
between about 5 wt. % and about 25 wt. % of the one or more fragrance materials, or
between about 95 wt. % and about 80 wt. % of the laundry detergent base, and
between about 5 wt. % and about 20 wt. % of the one or more fragrance materials, or
between about 95 wt. % and about 85 wt. % of the laundry detergent base, and
between about 5 wt. % and about 15 wt. % of the one or more fragrance materials, or
between about 95 wt. % and about 90 wt. % of the laundry detergent base and between about 5 wt. % and about 10 wt. % of the one or more fragrance materials.
